(19) United States
(12) Patent Application Publication
(10) Pub. No.: US 2002/0126813 A1
(43) Pub. Date: Sep. 12, 2002

(54) Phone based rewards programs method and apparatus prepared by tellme networks, Inc

(76) Inventors: Hadi Partovi, San Francisco, CA (US); David T. Bottoms, San Francisco, CA (US); Angus Macdonald Davis, Sunnyvale, CA (US); Eugene Koh, Palo Alto, CA (US); Michael S. McCue, Los Gatos, CA (US); Gregory N. Pal, Mountain View, CA (US); Patricia Shores, San Francisco, CA (US)

Correspondence Address: TELLME, C/O BEVER, HOFFMAN & HARMS, LLP, 2099 GATEWAY PLACE, SUITE 320, SAN JOSE, CA, 95110-1017, US

(21) Appl. No.: 09/755,872

(22) Filed: Jan. 5, 2001

(51) Int. Cl. G06F 17/60; H04M 15/00

(52) U.S. Cl. 379/114.12; 705/14

(57) ABSTRACT

A phone based loyalty rewards approach is described. The approach focuses on rewarding certain behaviors by maintaining a rewards balance usable for services such as free telephone calls. Users can be awarded some initial value of rewards balance at registration and then can earn additional rewards through their activities. Calls can be placed using voice dialing against a user supplied address book in one embodiment. Additionally, the rewards can be directly integrated with an advanced dial tone service offering and minutes spent on phone calls beyond the then available rewards balance charged to the user. The rewards are designed to encourage behaviors such as full and accurate registrations, regular usage, trying new features, etc.

### BACKGROUND OF THE INVENTION

1. Field of the Invention

This invention relates to the field of rewards programs for phone based applications. In particular, the invention relates to methods for awarding rewards and allowing spending of rewards in a phone based environment such as a voice portal.

2. Description of the Related Art

A number of industries use loyalty programs of one sort or another to encourage repeat business. For example, airlines have been awarding frequent flier miles for years now and customers can accumulate mileage from a number of participating partners from travel related partners to flower shops. Customers can then ultimately redeem their mileage points for free (or reduced cost) travel. Similar programs include buy N-get-1 free type programs, e.g. SuperCuts allows customers who get nine haircuts to get their tenth hair cut free. In the United States, Sperry & Hutchinson allows customers who collect Green Stamps (from grocery and other purchases) to use those points to get items from a catalog.

The prior techniques do not easily translate to a phone-based model further the prior techniques tend to either be focused on purchases (green stamps, buy N-get-M free, pointer per mile flown) or give-away/sponsor models (free long distance for listening to ads, read lots of ads to get special deals). Accordingly, what is needed is a method and apparatus for providing a customer loyalty program over a telephone based interface. The method and apparatus should encourage user loyalty to the phone based service and provide incentive to complete specific tasks.

### SUMMARY OF THE INVENTION

A phone based loyalty rewards approach is described. The approach focuses on rewarding certain behaviors by maintaining a rewards balance usable for services such as free telephone calls. Users can be awarded some initial value of rewards balance at registration and then can earn additional rewards through their activities. Calls can be placed using voice dialing against a user supplied address book in one embodiment. Additionally, the rewards can be directly integrated with an advanced dialtone service offering and minutes spent on phone calls beyond the then available rewards balance charged to the user. The rewards are designed to encourage behaviors such as full and accurate registrations, regular usage, trying new features, etc.

In one embodiment, the rewards program supplements a DIALTONE 2.0(™) service from Tellme Networks, Inc. In this embodiment, a user's telephone may automatically be connected to a phone application platform 110 without the need to dial any digits, e.g. you might pick the phone off the hook and hear “Tellme . . . ”, etc. In some embodiments, the user may be required to a hit a short sequence of one or more buttons (or a dedicate telephone handset button) to access DIALTONE 2.0, e.g. “00”. In this configuration, the user may use voice activated dialing, e.g. “Call Jane at home” or “Call Six-Five-O Nine-Three-O Nine Thousand”, etc. The user would then only be charged for those calls that exceed her/his available rewards balance.

### BRIEF DESCRIPTION OF THE FIGURES

FIG. 1 illustrates a system including embodiments of the invention used to support a phone-based rewards program.

FIG. 2 illustrates the components of a phone application platform supporting a phone-based rewards program.

### DETAILED DESCRIPTION

### Introduction

A method and apparatus for providing a phone-based reward program is described. This allows businesses to reward end users, or customers. End users of phone applications can use telephones, including wireless telephones, to access the phone applications and retrieve information, purchase goods and services, complete other tasks, and/or receive rewards. In some embodiments of the invention, the phone applications are able to retrieve information from the World Wide Web (WWW), databases, third parties, and/or other sources.

The features that developers can offer in their telephone application are constrained by the limitations—but also receive the advantages—of the particular implementation platform. For example, some platforms can receive dual-tone multi-frequency (DTMF or touch-tone) commands as well as spoken commands to further control the content presented and direct commerce transactions as well as the manner of presentation. The term audio request, or input, is used to refer to either a voice or touch-tone input, or a combination of the two types of input.

Similarly, different platforms may allow different levels of access to telephone identifying information. Developers may wish to use telephone identifying information to personalize caller interactions with their applications. Also, some platforms may provide a uniform state management mechanism for phone applications.

Applicants note several commonly owned and assigned co-pending patent applications relating to features provided by phone application platforms such as a voice portal:

| Serial # | Title | Filing Date |
|---|---|---|
| 09/466,236 | Method and Apparatus for Electronic | Dec 17 1999 |
| | Commerce Using a Telephone Interface | |
| 09/426,102 | Method and Apparatus for Content | Oct 22 1999 |
| | Personalization over a Telephone Interface | |

The invention will be described in greater detail as follows. First, a number of definitions useful to understanding the invention are presented. Then, the hardware and software architecture for a phone application platform supporting rewards is presented. Finally, the processes and features of phone-based rewards systems are presented in greater detail.

### Definitions

### Telephone Identifying Information

For the purposes of this application, the term telephone identifying information will be used to refer to ANI information, CID information, and/or some other technique for automatically identifying the source of a call and/or other call setup information. For example, telephone identifying information may include a dialed number identification service (DNIS). Similarly, CID information may include text data including the subscriber's name and/or address, e.g. “Jane Doe”. Other examples of telephone identifying information might include the type of calling phone, e.g. wireless, pay phone, and/or hospital phone.

Additionally, the telephone identifying information may include wireless carrier specific identifying information, e.g. location of wireless phone now, etc. Also, signaling system seven (SS7) information may be included in the telephone identifying information.

### User Profile

A user profile is a collection of information about a particular user. The user profile typically includes collections of different information of relevance to the user, e.g., account number, name, contact information, user-id, default preferences, and the like. Notably, the user profile contains a combination of explicitly made selections and implicitly made selections.

Explicitly made selections in the user profile stem from requests by the user to the system. For example, the user might add business news to the main topic list. Typically, explicit selections come in the form of a voice, or touch-tone command, to save a particular location, e.g. “Remember this”, “Bookmark it”, “shortcut this”, pound (#) key touch-tone, etc., or through adjustments to the user profile made through the web interface using a computer.

Additionally, the user profile provides a useful mechanism for associating telephone identifying information with a single user, or entity. For example, Jane Doe may have a home phone, a work phone, a cell phone, and/or some other telephones. Suitable telephone identifying information for each of those phones can be associated in a single profile for Jane. This allows the system to provide uniformity of customization to a single user, irrespective of where they are calling from.

In contrast, implicit selections come about through the conduct and behavior of the user. For example, if the user repeatedly asks for the weather in Palo Alto, Calif., the system may automatically provide the Palo Alto weather report without further prompting. In other embodiments, the user may be prompted to confirm the system's implicit choice, e.g. the system might prompt the user “Would you like me to include Palo Alto in the standard weather report from now on?”

Additionally, the system may allow the user to customize the system to meet her/his needs better. For example, the user may be allowed to control the verbosity of prompts, the dialect used, and/or other settings for the system. These customizations can be made either explicitly or implicitly. For example if the user is providing commands before most prompts are finished, the system could recognize that a less verbose set of prompts is needed and implicitly set the user's prompting preference to briefer prompts.

### Topics and Content

A topic is any collection of similar content. Topics may be arranged hierarchically as well. For example, a topic might be business news, while subtopics might include stock quotes, market report, and analyst reports. Within a topic different types of content are available. For example, in the stock quotes subtopic, the content might include stock quotes. The distinction between topics and the content within the topics is primarily one of degree in that each topic, or subtopic, will usually contain several pieces of content.

### Demographic and Psychographic Profiles

Both demographic profiles and psychographic profiles contain information relating to a user. Demographic profiles typically include factual information, e.g. age, gender, marital status, income, etc. Psychographic profiles typically include information about behaviors, e.g. fun loving, analytical, compassionate, fast reader, slow reader, etc. As used in this application, the term demographic profile will be used to refer to both demographic and psychographic profiles.

### Cookie

The term cookie, as used herein, refers to a structured data element formatted according to the general principles of IETF RFC 2109 and/or some other state management standard.

A brief review of RFC 2109 may be useful. The core structure of a cookie is a name-value pair. The name is a token for identifying the cookie, e.g. “Customer”, and the value is the value of that corresponding token, e.g. “Jane Doe”.

Implicitly, each cookie is associated with the sending domain. According to RFC 2109, the implicitly set domain is the originating domain to which the HTTP request was sent. For example, if an HTTP GET request is sent to the request host “www.example.com”, then the cookie set in response to that request would be implicitly associated with “www.example.com”

Additionally, a number of optional fields can be set, for example: a different domain for which the cookie is valid (Domain); a time to live (Max-Age); a version string (Version); etc. The phrases in parenthesis correspond to the RFC 2109 standard field names for the options.

### Voice Portal Overview

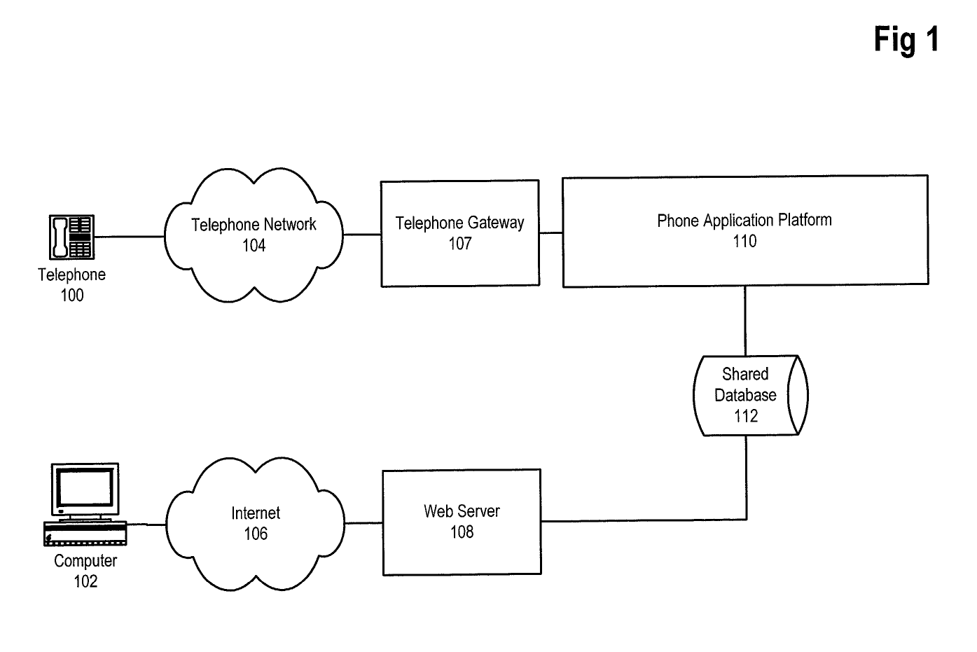

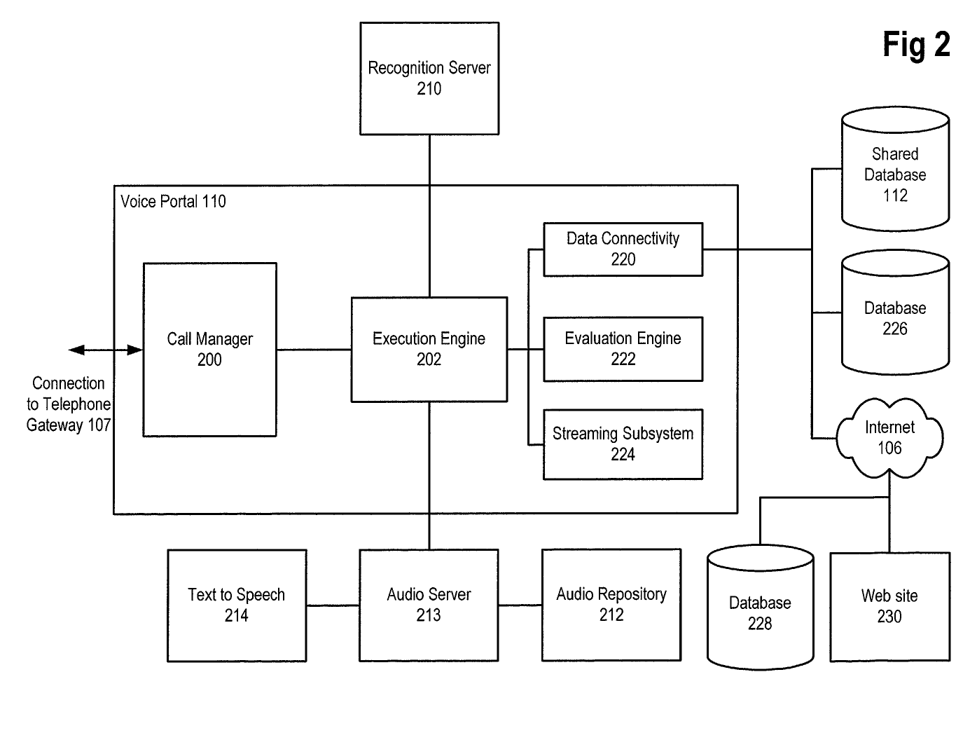

First, the hardware and software architecture of a system including an embodiment of the invention will be described with reference to FIGS. 1-2. FIG. 1 illustrates a system including embodiments of the invention used to support remotely hosted phone application development. The system of FIG. 1 can be used to allow developers with a standard computer and a telephone, or wireless telephones, to develop telephone applications without the need for specialized hardware and/or software.

The following lists the elements of FIG. 1 and describes their interconnections. FIG. 1 includes a telephone 100, a computer 102, a telephone network 104, an Internet 106, a telephone gateway 107, a web server 108, a phone application platform 110, a shared database 112, and a phone application 114. The telephone 100 is coupled in communication with the telephone network 104. The telephone network 104 is coupled in communication with the telephone gateway 107. The telephone gateway 107 is coupled in communication with the phone application platform 110. The computer 102 is coupled in communication with the Internet 106. The Internet 106 is coupled in communication with the web server 108. The web server 108 is coupled to the shared database 112. The shared database 112 is coupled in communication with the web server 108 and the phone application platform 110.

The following describes each of the elements of FIG. 1 in greater detail. The telephone 100 is a telephone interfaces to the phone application platform 110. The telephone 100 may be any sort of telephone and/or wireless telephone. For example the telephone 100 may be a land line phone, a PBX telephone, a satellite phone, a wireless telephone, and/or any other type of communication device capable of providing voice communication and/or touch-tone signals over the telephone network 104. However, any audio signal carrying interface could be used.

The telephone network 104 may be the public switched telephone network (PSTN) and/or some other type of telephone network. For example, some embodiments of the invention may allow users with a voice over Internet Protocol (IP) phone to access the phone application platform 110. The telephone network 104 is coupled to the telephone gateway 107 that allows the voice communications and/or touch-tone signals from the telephone network 104 to reach the phone application platform 110 in usable form. Similarly, the telephone gateway 107 allows audio signals generated by the phone application platform 110 to be sent over the telephone network 104 to respective telephones, e.g. the telephone 100. The telephone network 104 generally represents an audio signal carrying network.

The computer 102 is a computer such as a personal computer, a thin client computer, a server computer, a handheld computer, a set top box computer, and/or some other type of visual web browsing device. The computer 102 is coupled in communication with the Internet 106, e.g. by a dial-up connection, a digital subscriber loop (DSL), a cable modem, and/or some other type of connection. This allows the computer 102 to communicate with the web server 108 and the web server 101. The computer 102 typically provides a visual interface to the WWW and the web server 108 using web browsing software such as Internet Explorer(™) from Microsoft Corporation, Redmond, Wash.

The web server 108 is a web server provides web based access to one or more features of applications hosted on the phone application platform 110. For example, a user might use the computer 102 to review past purchase by way of the web server 108.

FIG. 2 illustrates the components of a phone application platform supporting remotely hosted phone application development. This could be used to support the phone application platform 110 and allow for remotely hosted phone application development. This description describes one particular phone application platform; however, the remotely host application development method and apparatus are not particular to this phone application platform.

The following lists the elements of FIG. 2 and describes their interconnections. The phone application platform 110 is coupled in communication with the telephone gateway 107. The phone application platform 110 includes a call manager 200, an execution engine 202, a data connectivity engine 220, an evaluation engine 222 and a streaming engine 224. Additionally FIG. 2 includes elements that may be included in the phone application platform 110, or which may be separate from, but coupled to, the phone application platform 110. Thus FIG. 2 also includes a recognition server 210, an audio server 213, a text to speech server 214, an audio repository 212, the shared database 112, a database 226, the Internet 106, a database 228 and a web site 230. The call manager 200 within the phone application platform 110 is coupled to the execution engine 202. The execution engine 202 is coupled to the recognition server 210, the audio server 213, data connectivity engine 220, the evaluation engine 222 and the streaming engine 224. The data connectivity engine 220 is coupled in communication with the shared database 112, the database 226 and the Internet 106. The Internet 106 is coupled in communication with database 228 and the web site 230. The audio server 213 is coupled to the text to speech server 214 and the audio repository 212.

The following describes each of the elements of FIG. 2 in greater detail. In some embodiments of the invention, the phone application platform 110 is implemented using one or more computers. The computers may be server computers such as UNIX workstations, personal computers and/or some other type of computers. Each of the components of the phone application platform 110 may be implemented on a single computer, multiple computers and/or in a distributed fashion. Thus, each of the components of the phone application platform 110 is afunctional unit that may be divided over multiple computers and/or multiple processors. The phone application platform 110 represents an example of a telephone interface subsystem. Different components may be included in a telephone interface subsystem. For example, a telephone interface subsystem may include one or more of the following components: the call manager 200, the execution engine, the data connectivity 220, the evaluation engine 222, the streaming subsystem 224, the audio repository 212, the audio server 213, the text to speech 214 and/or the recognition engine 210.

The call manager 200 is responsible for scheduling call and process flow among the various components of the phone application platform 110. The call manager 200 sequences access to the execution engine 202. Similarly, the execution engine 202 handles access to the recognition server 210, the audio server 213, the data connectivity engine 220, the evaluation engine 222 and the streaming engine 224.

The recognition server 210 supports voice, or speech, recognition. The recognition server 210 may use Nuance 7 recognition software from Nuance Communications, Menlo Park, Calif., and/or some other speech recognition product. The execution engine 202 provides necessary grammars to the recognition server 210 to assist in the recognition process. The results from the recognition server 210 can then be used by the execution engine 202 to further direct the call session. Additionally, the recognition server 110 may support voice login using products such as Nuance Verifier(™) and/or other voice login and verification products. Additionally, not shown in the figure, the recognition server 210 may use HTTP, or other suitable protocols, to retrieve grammars identified using a uniform resource indicator (URI) from servers. These requests can access servers across the Internet 106, e.g. a grammar stored on the web site 230.

The audio server 213 provides audio playback capabilities and uses a text to speech server 214 and an audio repository 212 to obtain some of the sounds presented in the system. According to one implementation, the <AUDIO> VoiceXML tag is supported in such a fashion that if the requested SRC file cannot be obtained, the text to speech server 214 is requested to generate speech for the tag contents. For example, “<AUDIO SRC=”number98.wav“>98</AUDIO>” would result in the audio server 213 first attempting to retrieve the source file “number 98.wav” from the audio repository 212, or other specified server using HTTP, or other suitable protocols. If the file is unavailable, cannot be retrieved, or cannot be retrieved in a timely enough fashion, the text to speech server 214 is automatically called to generate the speech synthesized version of the provided text, in this case the number “98”.

Additionally, the audio server 213 can adjust the timing, balance, and eliminate audio artifacts (e.g., “clean”) in the sounds being played back so as to provide an aurally smooth and pleasing sound to the user. Further, when appropriate, the execution engine 202 may batch a group of <AUDIO> and <PAUSE> commands together and to pass them to the audio server 213. This allows for the most natural playback of sounds from a timing standpoint. The basic grouping criteria is that there be no intervening commands unrelated to audio playback.

Additionally, the audio server can support retrieval of non-static materials, e.g. streaming audio, audio data feeds, and/or other types of audio data. Embodiments of the invention may include appropriate software for accessing common streaming protocols and their data streams, e.g. RealAudio(™), RealVideo(™), QuickTime(™), etc., using the audio server 213.

The text to speech server 214 supports the conversion of text to synthesized speech for transmission over the telephone gateway 107. For example, a request that the phrase, “The temperature in Palo Alto, Calif., is currently 58 degrees and rising” be spoken to a caller could be made. That phrase would be translated to speech by the text to speech server 214 for playback over the telephone network on the telephone (e.g. the telephone 100). Additionally the text to speech server 214 may respond using a selected dialect and/or other voice character settings appropriate for the caller.

The audio repository 212 may include recorded sounds and/or voices. In some embodiments the audio repository 212 is coupled to one of the databases (e.g. the database 226, the database 228 and/or the shared database 112) for storage of audio files. The audio repository server 212 responds to requests to play a specific sound or recording. According to some embodiments of the invention, the audio repository 212 is accessed according to the hypertext transfer protocol (HTTP).

For example, the audio repository 212 may contain a standard voice greeting for callers to the phone application platform 110, in which case the execution engine 202 could request play-back of that particular sound file. The selected sound file would then be delivered by the audio repository 212 through the call manager 200 and across the telephone gateway 107 to the caller on the telephone, e.g. the telephone 100. Additionally, the telephone gateway 107 may include digital signal processors (DSPs) that support the generation of sounds and/or audio mixing.

The execution engine 202 supports the execution of multiple threads with each thread operating one or more applications for a particular call to the phone application platform 110. Thus, for example, if the user has called in to the phone application platform 110, a thread may be started to provide her/him a voice interface to the system and for accessing other options.

In some embodiments of the invention an extensible markup language (XML)-style language is used to program applications. Each application is then written in the XML-style language and executed in a thread on the execution engine 202. In some embodiments, an XML-style language such as VoiceXML from the VoiceXML Forum, see <http://www.voicexml.org/>, is extended for use by the execution engine 202 in the phone application platform 110.

Additionally, the execution engine 202 may access the data connectivity engine 220 for access to databases and web sites (e.g. the shared database 112, the web site 230), the evaluation engine 222 for computing tasks and the streaming engine 224 for presentation of streaming media and audio. The streaming engine 224 may allow users of the phone application platform 110 to access streaming audio content, or the audio portion of streaming video content, over the telephone interface. For example, a streaming media broadcast from ZDNet(™) could be accessed by the streaming engine 224 for playback through the voice portal.

The data connectivity engine 220 supports access to a variety of databases including databases accessed across the Internet 106, e.g. the database 228, and also access to web sites over the Internet such as the web site 230. In some embodiments the data connectivity engine can access standard query language (SQL) databases, open database connectivity databases (ODBC), and/or other types of databases. The shared database 112 is represented separately from the other databases in FIG. 2; however, the shared database 112 may in fact be part of one of the other databases, e.g. the database 226. Thus, the shared database 112 is distinguished from other databases accessed by the phone application platform 110 in that it contains user profile information.

In some embodiments of the invention, specialized database systems such as Infranet(™) from Portal Software, Inc., Cupertino, Calif., are used to maintain billing and user account information. In these embodiments the shared database 112 may be one or more Infranet database in combination with one or more other databases.

The processes and features of phone-based rewards systems will now be presented in greater detail.

### Rewards Programs

For convenience, the rewards programs will be discussed in terms of minutes. For example, a reward might be described as a user receiving N minutes. However, in some embodiments, the rewards are directly distributed in an alternative reward “currency”, e.g. 10ths of a minute, frequent flier points, green stamps, etc. In still other embodiments, it may be possible for users to directly exchange their rewards currency for other currencies, e.g. trade minutes for frequent flier miles, etc., as opposed to using the rewards in the natural format, e.g. minutes to place telephone calls at no charge. Additionally, where specific numbers of minutes for a particular reward is described, those are examples only and can be adjusted based on the underlying costs and desired level of reward. For example, if minutes are the reward “currency”, if an activity is described as providing 10 minutes, it could equally be provide a lesser or greater number of minutes.

The focus of the rewards should be on building customer loyalty to an overall set of predominantly phone-based services. As a result rewards should be task specific in nature and, where possible, provide incentives for the user to perform complex tasks that might otherwise not be perceived as having sufficient value to the user.

### Overview and Example

An example will be helpful, voice enrolled registration of a user is a somewhat complex task, and the more information requested the more complex the user's task. Accordingly, a specific tangible award could be associated with the registration task, e.g. 30 minutes. The reward might only be offered if the user provides specific information, e.g. home address, electronic mail address, etc. Similarly the use of reward minutes may be constrained either on a per award basis or on globally for a user.

Continuing the registration example, use of the 30 minutes might be constrained to 5 minutes a day to reduce fraudulent registrations. However, perhaps after a given number of days after registration, all minutes might become available. Similarly, reward minutes may have an explicit expiration date, e.g. one year, and they may, or may not, be extendible (e.g. by paying a fee, continuing to use the services, etc.).

### Implementation Details

In some embodiments of the invention, each user is associated with at least one user profile. This user profile may be stored in part or whole in the shared database 112. The user profile can include one or more datum indicating an account of minutes. (Again minutes are used for example purposes.) In one embodiment a record of all activities that lead to the current account of minutes can be accessed either directly in the shared database 112 and/or with reference to one or more other databases. The record of activities may include both those activities that added minutes to the account as well as those that removed minutes.

If minutes are used for rewards, some embodiments, may also allow users to separately purchase minutes for their account, e.g. over the phone/web using one or more forms of payment such as a phone/web wallet, credit card, and/or some other payment mechanism. These purchased minutes can be used like reward minutes; although, they may be subject to fewer restrictions, e.g. never expire, all usable whenever desired, etc.

Additionally, one or more mechanisms may be provided to allow users to check their reward balances. For example, in one embodiment, an electronic mail message is generated either on request or at periodic intervals to apprise user's of their rewards balance. In other embodiments, a web page can be accessed to review the use of rewards and current balance. In other embodiments, a phone based interface is provided for checking rewards. Also, if the rewards program is integrated with some other regularly billed fees, e.g. phone service bills, then information about rewards can be provided with such bills in the appropriate format.

### Earning Rewards

The following lists several preferred mechanisms for providing awards. As noted above these mechanisms are focused on customer loyalty and encouraging certain behaviors. Additionally, some of the mechanisms may be available over the phone, the web, and/or a combination of the two.

Registration (Basic)—In one embodiment basic registration, e.g. providing one or more datum to associate with a user profile, results in a reward.

Registration (Supplemental)—In one embodiment supplemental registration, e.g. e-mail address, home mailing address, demographic information, etc., may result in a supplemental reward above and beyond any basic registration award. For example, a user might receive 20 reward minutes for completing basic registration and then another 20 for supplementing that registration.

Registration (Wallet)—In one embodiment, when a user signs up for a wallet feature to facilitate voice commerce, she/he is credited with additional reward minutes.

Referrals—In one embodiment, when a user refers another person to become a member a reward is provided. In one embodiment, referrals are made by providing a specially formatted link to a web sign up page to referee. When the referee uses that link to sign up, the user is credited with reward minutes. (Note, also that the referee may also be eligible to receive reward minutes for registration.) In other embodiments, when the user calls a person and that person subsequently calls back and registers, the user receives referral credits.

Frequency/Usage Based Rewards Program—In one embodiment, users earn rewards in proportion to their use of the service. For example, users who access the phone application platform a predetermined number of times per month, for a predetermined amount of time and/or with a predetermined frequency (e.g. weekly, daily), could be awarded appropriate rewards. For example, in one embodiment, awards are provided monthly based on conduct in the previous month, for example a regular caller (once per week for at least n minutes of non-phone calling usage) would receive some proportionate amount of minutes to use in the following month(s).

Use New Feature (optionally including feedback)—In one embodiment, rewards are provided to users who try a new feature (possibly a predetermined number of times or to complete certain tasks), for example, try two Tellme wakeup calls and receive a reward. In some embodiments, the user may be requested to provide feedback and in some instances the feedback may be required before the reward is provided.

Treasure Hunt—In one embodiment, rewards are “hidden” throughout the applications available on the phone application platform. Callers therefore earn rewards by using the multiple services and applications and in the process they will “discover” the rewards. In one embodiment, a caller must be logged in to be able to “discover” rewards. In one embodiment the rewards are “hidden” by selecting (randomly or according to some plan) call flow locations in the one or more applications to receive the rewards. For example, a reward might be “hidden” behind the part of the call flow where the user adds a stock to their favorites. Users would “discover” the reward when using the stock information application and adding a stock to their favorite.

Partner Provided Rewards—In some embodiments, one or more partners, affiliates, or other merchants that are associated with, featured on, available through, and/or otherwise involved with the phone application platform may be permitted to provide rewards to users. In these configurations the partner can be required to pay a portion of the reward amount, e.g. $Y for each reward unit, etc. However, in some embodiments, there may be no direct cash payment and any compensation would be indirect as by referral fees, revenue sharing, affiliates programs, advertising, barter transactions for other goods/services, and/or other indirect forms of compensation.

### Using Rewards

Rewards may be used in several fashions. The most straightforward mechanism is the placement of telephone calls. In this fashion, the user can place calls with the minutes coming out of her/his rewards balance. The basic call flow is straightforward: call the phone application platform 110, identify yourself (implicitly through telephone identifying information or explicitly with sign on), and place a call. In some embodiments, the calls can be placed directly from the entry point of the phone application platform 110, e.g as soon as the person dials the phone number if they are recognized through telephone identifying information they can immediately voice dial, e.g. from a phonebook associated with the user as in “Call Jane at home” or by annunciating the number, e.g. “Call Six-Five-Oh Nine-Three-Oh Nine Thousand”, etc. Additionally, touch-tone style dialing may be available as well.

In one embodiment, users are queried for their password (e.g. a PIN, voice verification, and/or other authorizing token) before rewards minutes can be used. In some embodiments, the query only occurs a single time per call, e.g. if after completing a first call the user goes to make a second call no query is made. Similarly, if the user explicitly logged in to access their account, the query may be skipped. The policy determination as to whether or not the password is queried can be set by the provider of the phone application platform 110.

In some embodiments, the call is automatically terminated when the user runs out of reward minutes. In other embodimetns the user may be permitted to extend past their minutes by a predetermined amount, e.g. one minute, etc. In other embodiments, additional minutes beyond the reward minutes are charged to the user either by debit from prepaid minutes or subsequent billing of additional minutes.

### Advanced Dialtone Services

In one embodiment, the rewards program may supplement a DIALTONE 2.0(™) service from Tellme Networks, Inc., Mountain View, Calif. According to the DIALTONE 2.0 service, a customer's telephone (e.g. the telephone 100) may automatically be connected to the phone application platform 110 without the need to dial digits, e.g. pick up the phone and you hear “Tellme”, etc., instead of a dial tone. In other embodiments, the user may be required to hit a sequence of one or more buttons to access the service, e.g. “00 ” to reach the DIALTONE 2.0 service as if it was the long distance operator, etc. The user may then be able to use voice activated dialing, e.g. “Call Jane at home” or “Call Six-Five-O Nine-Three-O Nine Thousand”, etc. (As well as access other voice enabled features, e.g. “Tellme my Favorites”, accessible from the phone application platform 110.)

In the above embodiments, the user may be in a paying relationship with the provider of the advanced dial tone services and so rewards consumption would directly reduce their phone bill and extra minutes would typically be allowed (with the contractual understanding that the user would pay for the additional minutes at an agreed upon rate). For example, a user Sarah may receive DIALTONE 2.0 as part of her wireless service with WirelessCo. In such a configuration, she would pick up her wireless phone and use it normally; however, she could reduce use of her paid minutes by earning, and consuming, rewards minutes.

Additionally, the advanced dial tone services may include capabilities such as hosted address book with synchronization capabilities. For example, in one embodiment a service such as a myYahoo! is integrated with the DIALTONE 2.0 services to provide a seamless handheld-web-phone address book experience that includes contact synchronization, favorites synchronization, and data availability.

### Conclusion

In some embodiments, processes of FIGS. 1-2 can be implemented using hardware based approaches, software based approaches, and/or a combination of the two. In some embodiments, phonemic transcription and generation of phonemic variations are carried out using one or more computer programs that are included in one or more computer usable media such as CD-ROMs, floppy disks, or other media. In some embodiments, transcription generation programs, script handling programs, phonemic variation generation programs, script handling programs, and/or syllabication programs, are included in one or more computer usable media.

Some embodiments of the invention are included in an electromagnetic wave form. The electromagnetic waveform comprises information such as transcription generation programs, script handling programs, phonemic variation generation programs, script handling programs, and/or syllabication programs. The electromagnetic waveform may include the programs accessed over a network.

The foregoing description of various embodiments of the invention has been presented for purposes of illustration and description. It is not intended to limit the invention to the precise forms disclosed. Many modifications and equivalent arrangements will be apparent.

1. A method for providing loyalty rewards for a phone based application system over a telephone interface using a computer system, the method comprising:
receiving a request over the telephone interface, the request corresponding to a request to register as a user with the phone based application system;
creating a user profile in response to the request, the user profile including a rewards balance set to a non-zero amount; and
permitting the user to place telephone calls over the telephone interface by consuming the rewards balance until value of the rewards balance reaches zero, the placed telephone calls at no additional cost to the user beyond any costs for accessing the phone based application system.

2. The method of claim 1, wherein the permitting comprises supporting voice dialing by name of call recipients from an address book associated with the user profile.

3. The method of claim 1, wherein the phone based application system comprises an advanced dial tone service.

4. The method of claim 3, wherein the permitting comprises distinguishing between requests to place phone calls and requests for information content.

5. The method of claim 3, wherein the permitting further comprises allowing phone calls to proceed after value of the rewards balance reaches zero.

6. The method of claim 5, wherein the method further comprises billing the user for placed phone calls that exceed value of the rewards balance after value reaches zero.

7. The method of claim 1, wherein the non-zero amount determined proportionately to the quantity of information provided by the user and the non-zero amount higher for more information.

8. The method of claim 1, wherein the permitting comprises decrementing a predetermined amount of value from the rewards balance per unit of time during which the user is placing a telephone call.

9. The method of claim 1, wherein the method further comprises permitting the user to increase value of the rewards balance by using the phone application system in one or more predetermined fashions.

10. The method of claim 9, wherein the one or more predetermined fashions comprises providing additional registration information for the user profile over a web based interface.

11. The method of claim 9, wherein the one or more predetermined fashions comprises referring a new user to the phone application system.

12. The method of claim 9, wherein the one or more predetermined fashions comprises using the phone application system with one or more of a predetermined frequency and a predetermined amount per unit time.

13. The method of claim 9, wherein the one or more predetermined fashions comprises trying a recently added feature of the phone application system.

14. The method of claim 9, wherein the one or more predetermined fashions comprises a phone based treasure hunt.

15. The method of claim 9, wherein the one or more predetermined fashions comprises performing a commerce transaction with one or more of operator of the phone application system and a different legal entity providing an application service on the phone application system.

16. An apparatus for providing loyalty rewards for a phone based application system over a telephone interface using a computer system, the apparatus comprising:
means for receiving a request over the telephone interface, the request corresponding to a request to register as a user with the phone based application system;
means for creating a user profile in response to the request, the user profile including a rewards balance set to a non-zero amount; and
means for permitting the user to place telephone calls over the telephone interface by consuming the rewards balance until value of the rewards balance reaches zero, the placed telephone calls at no additional cost to the user beyond any costs for accessing the phone based application system.

17. The apparatus of claim 16, wherein the means for permitting further comprises means for supporting voice dialing by name of call recipients from an address book associated with the user profile.

18. The apparatus of claim 16, wherein the phone based application system comprises an advanced dial tone service comprising means for detecting a phone off hook condition in the telephone interface and providing voice activated dial tone services from one or more processing means remote to a telephone coupled to the telephone interface.

19. The apparatus of claim 16, wherein the phone based application system comprises means for synchronizing an address book with a handheld computer system.
